(19) United States
(12) Patent Application Publication
(10) Pub. No.: US 2020/0024895 A1
(43) Pub. Date: Jan. 23, 2020

(54) BUTT JOINT GLAZING

(71) Applicant: Saint-Gobain Glass France, Courbevoie (FR)

(72) Inventors: Ralf Linden, Aachen (DE); Dennis Gresförder, Bad Oeynhausen (DE); Manfred Möllers, Paderborn (DE); Christoph Bayer, Bonn (DE); Ulrich Hermens, Aachen (DE); Rolf Kochs, Aachen (DE)

(21) Appl. No.: 16/090,706

(22) PCT Filed: Apr. 4, 2017
(86) PCT No.: PCT/EP2017/057984

§ 371 Date: Oct. 2, 2018

(30) Foreign Application Priority Data
Apr. 4, 2016 (EP) 16163735.0

(51) Int. Cl. E06B 5/16; B32B 17/10; B32B 17/06; B32B 7/08; E06B 7/28

(52) U.S. Cl. CPC E06B 5/165; B32B 17/10055; E06B 7/28; B32B 17/069; B32B 7/08; B32B 17/10311

(57) ABSTRACT

A transparent safety panel for producing resistant, surface flush butt joint glazing, including two plates and a receiving profile. The two plates are spaced apart from each other and are arranged substantially parallel to each other. The safety panel has an abutting end side and a mounting end side extending at a right angle from the abutting end side. The mounting end side can be mounted in the frame and permit fixing of the safety panel in the frame. The receiving profile is arranged between the spaced apart plates in a border region in the vicinity of the abutting end side. The receiving profile forms an open groove towards the abutting end side. A further safety panel can be connected to the safety panel in a surface flush manner without an additional frame via the abutting end side of the safety panel with the groove.

### BACKGROUND OF THE INVENTION

### Field of the Invention

The invention generally relates to the field of resistant butt joint glazing, and, more particularly, to a safety panel and to a set for producing frameless, surface-flush butt joint glazing, and butt joint glazing with free abutting edges, and an insert element for use in butt joint glazing.

### Description of Related Art

Surface-flush fire-protection glazing with monolithic embodiments or insulating glass designs is known from the prior art. Such butt joint glazing consists of a plurality of individual glazing units which are connected to one another in a surface-flush manner. Although the butt joint glazing is capable of forming visually attractive, surface-flush glazing with a fire-protection function, such glazing does not, however, satisfy the requirements for increased safety, such as, for example, attack-resistant glazing of resistance class RC1-RC6 (EN 1627:2011), bullet resistance according to EN 1063:2009 or resistance against explosion pressure according to EN 13541:2012. With the aid of attack-resistant glazing of resistance class RC1-RC6, it is not possible for a perpetrator with a simple, additional tool, such as, for example, a saw and an impact tool or an additional electric tool, such as an electric drill, to penetrate or break within nominatively defined times into the facility in which the surface-flush glazing is installed.

Safety glazing, for example of resistance class RC1-RC6 (according to EN 1627:2011) is, of course, known from the prior art. Such safety glazing is mounted on four sides and is composed of single-layer or multi-layer glass PVB laminates or glass polycarbonate laminates, as shown, for example, in EP 1194673, DE 20 2012 012285 or WO 2008/110021. Such glazing could previously only be used on four sides in correspondingly reinforced frame profiles and held in a shatter-proof or burglar-resistant manner. As a result, resistant, burglar-resistant safety glazing includes an encircling four-sided mounting of the individual glazing units. Due to the width of the generally specially reinforced frame profiles, the four-sided mounting has an architecturally inelegant and clumsy effect and therefore does not correspond to surface-flush glazing or butt joint glazing.

For example, glazing of the classes from P6B to P8B of the standard EN 1627:2011 describes “attack-resistant glazing with shatter proofing”. In the testing method, an attempt is made between 30 to over 70 times to bring about a square rupture with an edge length of 400 mm using an axe.

Surface-flush glazing, which is mounted on two sides and has free vertical edges or abutting edges, what is referred to as butt joint glazing, is known from the prior art, for example from EP 1194673. In the case of such glazing, the experienced perpetrator (burglar) has previously managed to gain access relatively rapidly to the facility by using the appropriate tool to attack the glass edge, which is not enclosed in an encircling manner in a frame profile, i.e. the free abutting edge. Mechanical attack on the presumably weaker joint between two adjacent panes is clearly the weak point of glazing mounted only on two sides.

Glass leaves without an outer frame with an encircling carrying and/or border closure element are known from the prior art, for example from EP 1020605. Furthermore, DE 19933400 discloses a fire-protection wall, which is modularly constructed from subcomponents. Each subcomponent has an encircling frame consisting of profiles. The undercut frame can receive a connecting element. The connecting element is suitable for a punctiform connection. DE3714629 discloses a façade wall of a building. The façade wall has an outwardly protruding profile carrier. The profile carrier is screwed at points in the end region with a holder between two panes. FR2662739 describes a pane assembly having an undercut encircling frame.

### SUMMARY OF THE INVENTION

It is an object of the invention to provide butt joint glazing which is mounted on two sides and has free abutting edges and is in the form of surface-flush glazing, without frame profiles projecting out of the glazing surface, and which permits increased safety with respect to attack, burglary, bullets and/or the effect of an explosion, i.e. is resistant.

This object is achieved by a safety panel and a set for producing resistant, surface-flush butt joint glazing with free abutting edges, and also a butt joint glazing with the features of the corresponding patent claims.

The safety panel is substantially transparent. In this connection, transparent means transparent and translucent, i.e. light-transmitting. In other words: the safety panel is translucent or translucid. Within the context of the invention, frameless means that the individual glazing units, i.e. safety panel, are not enclosed in a frame profile in an encircling manner, but rather are mounted in a frame on two sides or, on the outer sides of the building opening, on three sides, i.e. not on four sides, and not in an encircling manner. Individual adjacent safety panels in the butt joint glazing therefore include a free abutting edge and are held only on two sides in a frame. However, the butt joint glazing includes resistant, in particular burglar-resistant properties. Within the context of the invention, “resistant” means that there is a property which is shatter-proof, bullet-resistant and/or resistant against explosion pressure. The butt joint is arranged between the adjacent safety panels of the butt joint glazing. The butt joint is substantially arranged between the abutting edges and/or the abutting end sides of the adjacent safety panels of the butt joint glazing.

The safety panel for producing resistant, surface-flush butt joint glazing has at least two substantially transparent plates, namely a first plate and a second plate, and also a reinforcing profile. The reinforcing profile can also be referred to as a receiving profile. The two plates are spaced apart from each other by a distance (D). The two plates are arranged substantially parallel to each other. The safety panel has an abutting end side and a mounting end side extending substantially at a right angle from the abutting end side of the safety panel. The mounting end side can be mounted in a frame, also called outer frame, and permits fixing of the safety panel in the frame or in the building opening. A further safety panel can be arranged adjacent to the abutting end side in order to form butt joint glazing. The outer frame can protrude out of the plane of the surface-flush butt joint glazing and can be arranged on the outer border of the resistant butt joint glazing.

The safety panel and/or the plate are/is a surface element that has two substantially parallel large outer surfaces, which are also called flat sides. The encircling surface regions of the safety panel or of the plate between the flat sides are called “end sides” in this text, and the terms “edge” or “narrow side” of a safety panel or a plate can also be used therefor. The end side here has a smaller surface than the flat sides, and an extent of the end side perpendicularly to the large surfaces, i.e. the flat sides, corresponds to the thickness of the safety panel or of the plate. A border region of the safety panel and/or of the plate, which can be arranged in a frame, may also be referred to as a border flange. The border region is therefore a region of the safety panel and/or of the plate that is arranged in the vicinity of the end side. A rectangular safety panel or a rectangular plate has four end sides, and here two opposite end sides can be referred to as mounting end sides and the other two end sides can be referred to as abutting end side. The safety panel can be received in the outer frame at the mounting end side. The abutting end side running substantially perpendicularly to the mounting end side and with the receiving profile is configured to receive an insert element.

The substantially surface-flush butt joint glazing can be substantially surface-flush on both sides, i.e. with respect to the two outer flat sides.

The receiving profile is arranged between the two spaced-apart plates. The receiving profile is arranged in a border region of the abutting end side of the safety panel, and the receiving profile includes a receptacle, also called open receiving profile side, which is open or is opened toward the abutting end side. This abutting end side with the receptacle or the open receiving profile side may also be called connection side or abutting side. A further safety panel are connected to the safety panel in a surface-flush manner without an additional frame between the two safety panels via the connection side or abutting side.

The receiving profile is configured such that the insert element can be inserted or pushed, i.e. is pushable or insertable, into the receiving profile along a push-in axis. The push-in axis runs substantially perpendicularly to the abutting end side. The push-in axis can run substantially parallel to the mounting end side.

The insert element can be inserted or pushed and/or positioned into/in the receiving profile substantially without effort. That is to say, the insert element can be simply inserted into the receiving profile. No frictional forces, spring forces, torques or the like have to be overcome here during the inserting and/or pushing-in. This permits simple production of the resistant butt joint glazing.

The receiving profile can be configured in a manner substantially free from undercuts. The insert element can thereby be simply inserted and/or pushed in. This permits simple production of the resistant butt joint glazing. In contrast thereto, in the case of an undercut receiving profile, the correspondingly configured insert element would have to be pushed in parallel to the abutting end side. Wedging or even damage to the panel and/or the insert element may occur here.

The receiving profile can form an open groove toward the abutting end side. The groove can an undercut-free region for receiving an insert element which supports strengthening of the butt joint. The freedom from undercuts can refer here to the push-in axis.

The receiving profile can be arranged along the butt joint, in particular the receiving profile can be arranged along the entire butt joint and/or abutting end side, i.e. can be arranged over the entire length of the butt joint and/or abutting end side. Continuous resistance of the butt joint can thereby be brought about. Such a continuous resistance can prevent the formation of attack points which may occur, for example, in the case of point-type anchorings.

The receptacle of the receiving profile can have substantially the same cross section over the entire length. As a result, insertion and/or pushing-in of the insert element over the entire length can be simplified.

The mounting side can be free from the receiving profile, in particular free from a continuous receiving profile. No insert element is inserted and/or pushed in on the mounting side. This especially reinforces the abutting end side and improves the resistance of the butt joints. The mounting in the outer frame can be independent of the butt joint resistance. The mounting end side can be mounted in the outer frame.

The receiving profile protects the edge region, i.e. the region in the vicinity of the end side, against damage, in particular in the event of a burglary, when under fire and/or the effect of an explosion and therefore supports the protective function and the resistance of the butt joint glazing or the safety panel.

The first plate and/or the second plate can include or be composed of glass having resistant properties. The plate can be a thermally or possibly chemically prestressed glass pane. As alternatives to glass panes on the basis of silicon oxide, transparent carriers on the basis of polymer (for example, composed of polycarbonates or poly-methyl-methacrylate (PMMA; acrylic glass), partially crystalline “glass” (ceramic glass), borosilicate glass or composite systems with glass panes and plastics carriers are also suitable. The plate does not have to be exclusively composed here of glass material, it may also include, for example, a plastic (i.e. in particular a polymer, if need be with, for example, inorganic fillers), e.g., acrylic glass as part of composite glass. The first plate and/or the second plate or the safety panel can correspond to the product standard according to EN1279.

The receiving profile can be permanently fastened in the border region. The position of the receiving profile relative to the safety panel can thus be precisely defined and the production of butt joint glazing with free abutting edges simplified.

The receiving profile can be fastened in the border region of the safety panel with a sealing compound. The sealing compound here can include, for example, silicone, polysulfide, polyurethane, other suitable construction adhesives and/or resins. The edge region in the vicinity of the abutting end side of the safety panel can thereby be further reinforced.

The receiving profile can be arranged in a contact-free manner with respect to the first or second plate in the border region of the safety panel. That is to say, the receiving profile can be arranged such that it does not have any contact with the first or second plate. Transmission of heat to the plates can thereby be reduced and/or prevented. This enables a reduction in the edge loading. The sealing compound here can bring about insulation and/or prevent contact between the plate and receiving profile.

The receiving profile can be arranged in a separated manner, in particular in a thermally separated manner, from the first and/or second plate.

The receptacle or open receiving profile side or the groove or the receiving profile can end in a substantially surface-flush manner and/or flush with the abutting end side of the safety panel. By means of the flush and/or surface-flush arrangement of the receptacle or of the groove or the receiving profile, simple positioning of a further safety panel adjacent to the safety panel can be made possible.

The receiving profile can be configured as a hollow profile, in particular as a U profile or L-shaped profile. The U profile has two first profile portions which are spaced apart from each other and a second profile portion running substantially perpendicularly to the two first profile portions, wherein the second profile portion is arranged between the two first profile portions.

The receiving profile can be configured in an L-shaped manner, with two profile portions running substantially perpendicularly to each other. A first profile portion can be arranged substantially parallel to the flat side of the first plate and/or second plate, and a second profile portion can be arranged substantially parallel to the abutting end side. The groove, i.e. the receptacle or open receiving profile side, is formed on one side by the first profile portion in this case.

The receiving profile, in particular the hollow profile, can include a dimensionally stable and/or resistant material, such as, for example, metal, in particular ferrous or nonferrous metal, in particular steel, and/or, for example, a plastic and/or a composite material.

The two plates, i.e. the first plate and the second plate, each have two flat sides. The flat sides of the two plates can substantially include identical dimensioning. The two plates therefore have the same size with respect to their flat side. However, they can include a different extent of the abutting end side or mounting end side, i.e. can have a different thickness and/or construction.

The flat sides of the first plate can be dimensioned larger than the flat sides of the second plate. Alternatively, the flat sides of the first plate can be dimensioned smaller than the flat sides of the second plate. A step-like abutting end side can thereby be formed.

The abutting end side can be of step-like design for the surface-flush receiving, i.e., surface-flush accommodating, of a fastening means, insert element and/or a covering. The step-like abutting end side can be formed by the fact that the flat sides of the first plate is dimensioned smaller in one direction than the second plate, or vice versa. The receiving profile can be fastened to the abutting end side of the safety panel between the two plates; for example, the receiving profile can be adhesively bonded to the abutting end side with the aid of the sealing compound. The covering here can cover the insert element and/or the receiving profile such that these are covered with respect to the outer side of the safety panel or of the butt joint glazing and are therefore protected. The covering can substantially extend over the length of the abutting end side.

The receiving profile can substantially extend over the entire length of the abutting end side.

The safety panel can include two receiving profiles which are each arranged in the border region of opposite abutting end sides of the safety panel between the spaced-apart plates. As a result, a substantially symmetrical construction of the safety panel can be made possible, as a result of which the production of butt joint glazing can be simplified.

The first plate and/or the second plate can be in the form of safety glazing, fire-protection glazing, insulating glazing and/or composite glazing. In particular, the fire-protection glazing can be at least in the form of E30 fire-protection glazing (EN 13501; EN 1364, EN 1363; status: April 2017). It is also possible for layers protecting against heat and/or sun and other functional and decorative glass to be able to be combined in the construction of the safety panel or of the plates. Privacy films, matt films, structural glass, or changeable glass can also be integrated into the construction of the plate. Movable slats, net curtains or films may also be introduced into the pane construction of the plates or safety panels. The plates can also include composite films and composite plates composed, for example, of PVB, in particular EVA and TPU, ionomers, structural interlayer, PMMA and PC.

The two adjacent plates can be spaced apart from each other with a spacer. The spacer can be arranged here further in the interior of the safety panel, i.e. displaced further toward the center point of the flat side of the safety panel, in comparison to the receiving profile.

The first plate and/or the second plate can include a monolithic and/or multi-layered pane composite. The multi-layer pane composite can include at least two spaced-apart glass panes composed of floating, composite, composite safety or thermally partially or completely prestressed single-pane safety glass. One or more intermediate layers which react to temperature in the event of fire, have a cooling effect, and/or become cloudy, foam, as known, for example, from EP 1194673, or are self-consuming can be contained between the spaced-apart glass panes. It is also possible for only part of the plate to include such a pane composite and/or fire-protection interlayer, i.e., fire-protection intermediate layer(s).

Safety panels in which part of the panel is composed of plates can include the composite films and composite plates composed, for example, of PVB, in particular EVA and TPU, ionomers, structural interlayers, PMMA or PC.

The first plate and/or the second plate can include an integrated alarm function. Such an alarm function can be configured, for example, as alarm protection, in which an alarm loop, i.e. an electrical conductor loop, is introduced into or applied to single-pane safety glass. When the plate is smashed, the current circuit of the alarm loop is interrupted and the alarm is triggered. When the plate is smashed, the resistance of the alarm protection can therefore be changed, thus changing a signal of the alarm protection and therefore triggering the alarm.

In other words: the safety panel or the plates or the butt joint glazing can combine different safety classes, such as, for example, attack resistance, bullet resistance, resistance against explosion pressure and/or fire protection, with one another. The construction of the safety panel or of the plates or of the butt joint glazing can be modified here in accordance with requirements. In particular, attack resistance, in particular burglary resistance, can be combined with a fire-protection function in the butt joint glazing.

The abutting end side run vertically in the butt joint glazing in the positioned state of the safety panel. The abutting end side runs along the butt joint. The safety panels can be arranged in a row horizontally next to one another. In another embodiment, with horizontally running abutting end sides, the safety panels can be arranged vertically one above another.

The space between the two adjacent plates can be filled with an inert gas.

The space between the two adjacent plates can be filled with a plate structure, in particular composite glazing and/or fire-protection glazing.

The set for producing burglar-resistant, frameless, surface-flush butt joint glazing with free abutting edges includes at least two previously described safety panels, i.e., a first safety panel and a second safety panel, and at least one insert element. The insert element includes a first portion and a second portion. The first portion is dimensioned such that it can be positioned in the receptacle or open receiving profile side, in particular the groove, i.e., the receiving profile, of the first of the two safety panels. In the positioned state, at least one portion of the insert element at least partially projects beyond the abutting end side of the first safety panel, in particular, the second portion of the insert element projects beyond the abutting end side of the first safety panel. The projecting portion of the insert element, in particular the second portion of the insert element, is dimensioned such that it can be positioned in the receptacle, in particular the groove, of the second of the two safety panels. In the positioned state of the insert element in the respective receptacle, in particular in the respective grooves, of the two safety panels, the two safety panels are arranged in a surface-flush manner with respect to each other. The production of surface-flush and burglar-resistant butt joint glazing with free abutting edges can thereby be facilitated.

The insert element can substantially extend over the entire length of the receiving profile. In the positioned state of the insert element in the respective receptacle or open receiving profile side, in particular in the respective grooves, of the two safety panels, a connection of the two safety panels over the entire length of the abutting end side can therefore be stabilized or reinforced. The insert element can extend substantially over the entire length of the butt joint end side of the safety panel.

The length of the insert element can exceed the length of the receiving profile, in particular the length of the butt joint end side, and, in the positioned state of the insert element in the respective receptacle, in particular in the respective grooves, of the two safety panels can project beyond the mounting end side. The insert element can thereby be fastened under some circumstances to an outer frame.

The insert element can be in the form of, for example, a flat profile or I profile, T profile and/or cross profile in a symmetrical and/or asymmetrical shape. The width of the T profile, i.e. the wide side, is formed by two feet, and the height of the T profile is formed by a web. The web extends substantially at a right angle from the feet. The feet can form the first portion or the second portion of the insert element.

The insert element can be insertable and/or pushable or positionable loosely in the receiving profile. The loose insertion or pushing-in permits simple production of the resistant butt joint glazing. Forcing in, wedging or twisting of the insert element in the receptacle can thus be prevented or reduced. During the insertion, a force-fitting and/or form-fitting connection does not arise between the receiving profile and the insert element.

The insert element can include a resistant material, in particular metal, in particular steel. It is also possible for the insert element to include a plastic, a material composite and/or a ferrous metal or nonferrous metal.

The insert element can also have recesses, the recesses do not influence the resistance and stability of the insert element. Heat bridges in the butt joint glazing can thereby be reduced. The weight of the butt joint glazing can thus also be reduced.

Increased safety requirements going beyond protection against falling or impact are imposed on butt joint glazing without and with fire-protection properties of fire resistance classes E30 to EI120 with free abutting edges (without encircling frame profiles around the individual safety panels) with two-sided mounting (e.g. top and bottom) in building inner and outer regions (e.g., partitions, window hinges, facades, sloping glazing). These requirements are met by the described butt joint glazing.

The first portion of the insert element and the second portion of the insert element can be configured such that they can be arranged in a positionally fixed manner, in particular in a positionally fixed manner with respect to each other and therefore cannot be twisted in relation to each other. In the positioned state with the two portions in the respective receiving profiles, the insert element cannot be rotated/twisted relative to the receiving profiles or the receptacles. The first and the second portion can be unitarily connected in one piece to each other. In one piece means that the two portions are connected nonseparably to each other. In one piece can also mean produced from one piece. In one piece can also mean that the insert element is not composed of a plurality of parts or produced from a plurality of parts.

The set can include a covering element that is configured to cover a butt joint, in particular the insert element, in the mounted state.

The set can include an additional insert reinforcement that can be fastenable to the insert element. The insert reinforcement can be fastenable to the insert element with a fastening means.

The fastening means can be configured as being in the manner of a screw, wherein the insert element and the insert reinforcement has an opening correspondingly adapted to the screw-shaped fastening means. The opening can include an internal thread, wherein the screw-shaped fastening means can include an appropriately corresponding external thread. The screw-shaped fastening means can be configured as a self-securing screw, i.e. as self-securing fastening means. The insert element can also be adhesively bonded to the insert reinforcement.

The insert reinforcement can extend over the entire length of the insert element.

The covering element can be fixed to the insert element, the insert reinforcement, the receiving profile, the fastening means and/or the abutting end side. The butt joint can be protected by such a fixing.

The set can include a band that is foamable or foams in the event of a fire and can be arranged between the first and the second safety panel, in the butt joint of the butt joint glazing. The foamable band can substantially extend over the entire length of the abutting end side, from one mounting end side to the other mounting end side, of the safety panel. The resistant, surface-flush butt joint glazing with free abutting edges includes a set, as described, and an outer frame. The butt joint glazing is a surface-flush glass façade or glazing. The two safety panels are arranged adjacent to each other along their abutting end side. The two safety panels are arranged in a surface-flush manner with respect to each other. Each of the two safety panels in each case has two opposite mounting end sides. The mounting end sides are each mounted or held in the outer frame. That is to say, a border region of the safety panel, in particular the mounting end side, enters the outer frame and is mounted or held in the border region. Such mountings of glazing in the frame are known to a person skilled in the art and serve for fastening/fixing glass panes in the frame. The mountings can be made possible, for example, by what is referred to as blocking. A butt joint is formed between the two adjacent safety panels, the butt joint corresponds to a cavity between the adjacent safety panels. Between the first safety panel and the second safety panel, the insert element is arranged beyond/spans the butt joint in the receptacle or open receiving profile side, in particular in the groove, of the first safety panel, and in the receptacle, in particular the groove, of the second safety panel. This permits stabilizing of the adjacent abutting edges of the butt joint glazing. The butt joint can be sealed with a seal or sealing compound. This permits protection against view and/or against external effects, such as weather, wind and/or moisture. The abutting edges run along the abutting end side and therefore extend substantially at a right angle to the outer frame. The abutting edges of the butt joint glazing are not covered by a frame, i.e. are frame-free or frameless. Visually attractive butt joint glazing including resistant, in particular burglar-resistant properties, is thereby provided.

The butt joint glazing can correspond to burglar-resistant butt joint glazing of the resistance classes RC1-RC6 (according to EN 1627:2011).

As already described, the insert element can be inserted or pushed in loosely in the receiving profile. The connection is therefore not force-fitting and/or form-fitting. On the contrary, the butt joint glazing forms a loose, two-sided composite, which can be reinforced by the insert element.

The seal and/or a sealing compound, which can fasten the receiving profile in the border region of the safety panel with a sealing compound, can include an opaque material. The insert element thereby remains concealed in the butt joint and is not visible to a skilled perpetrator (burglar).

The safety panel can include a screen print in the border region. The region in the vicinity of the butt joint can thereby be protected and the insert element concealed opaquely.

The butt joint glazing can also include further safety panels with receiving profiles in the two opposite end sides and further insert elements. The further safety panel can be arranged in a surface-flush manner between the first safety panel and the second safety panel and can be connected with the further insert element to the first safety panel and to the second safety panel without a frame and with free abutting edges.

The insert element can be designed such that it does not protrude out of the surface-flush butt joint glazing in the positioned state. That is to say, it does not protrude out of a plane which is defined by the butt joint glazing. The “plane” is spanned by the flat sides of the surface-flush safety panel. In other words: in the positioned state, the insert element protrudes out of the flat side or the plane or the flat side of the safety panels. This refers of course to the outer flat sides of the safety panels.

The insert element can be used in butt joint glazing, as described, and can extend along the abutting end side of the safety panel; in particular, the insert element can be configured as a T profile and/or cross profile in a symmetrical and/or asymmetrical shape.

The butt joint glazing can include the covering element of the set. The covering element is configured such that it substantially extends over the length of the butt joint. The covering element can be fastened in the region of the abutting end side of the adjacent safety panels; for example, the covering element can be adhesively bonded into the butt joint. The corresponding adhesive edge or adhesive joint can substantially extend over the entire length of the butt joint. As a result, the butt joint and/or the insert element can then be protected against applications of force from the outside, and the resistance of the butt joint glazing can be maintained. With the aid of the covering element, the insert element can be made accessible after complicated removal of the covering element. It is thereby possible to remove a damaged safety panel from the butt joint glazing and to insert a new safety panel into the butt joint glazing without having to disassemble the entire butt joint glazing. Such a simple exchange of safety panels can be advantageous in order over the long term to ensure visually attractive surface-flush butt joint glazing.

The covering element can be configured such that, in the inserted state in the butt joint glazing, it can be arranged in a substantially surface-flush manner with the flat sides of the adjacent safety panels. The covering element can include an opaque material. The covering element can in particular be arranged the butt joint between two safety panels having step-like abutting end side.

The band, which foams or is foamable in the event of a fire, can be arranged in the butt joint between the first and the second safety panel. The butt joint can thereby be sealed in the event of a fire, and passage of vapors, gases and/or direct heat radiation can be prevented after the foaming. The foamable band can substantially extend over the length of the butt joint.

The insert reinforcement can be fastened to the insert element. The resistance of the butt joint glazing can thereby be improved further. In particular, the insert reinforcement can be fastened to the insert element with the screw-shaped fastening means.

It is possible for the covering element to be fastenable to the fastening means, the insert reinforcement and/or the insert element. The covering element can be configured such that it can be clicked on or clicked in. As a result, destruction-free removal of the covering element, for example with a special tool, can be made possible.

As already described, the butt joint can run vertically between the first and the second safety panel.

The insert element and/or the insert reinforcement can be fastened, in particular adhesively bonded, in the receptacle or open receiving profile side, in particular in the groove, of the receiving profile.

A method for producing the resistant, surface-flush butt joint glazing can include the following steps:
providing a set as described;
providing an outer frame;
fastening the outer frame in a building opening;
mounting at least one mounting side of the first safety panel in the outer frame;
positioning or inserting or pushing the insert element in or into the receiving profile of the first safety panel;
positioning the receiving profile of the second safety panel adjacent to the first safety panel, wherein the second portion of the insert element is positioned in the receiving profile of the second safety panel.

When the insert element is inserted into the receptacle of the first safety panel, the first portion is positioned in the receiving profile of the first safety panel and the second portion projects beyond the beyond the abutting end side of the first safety panel. When the second safety panel is positioned adjacent to the first safety panel, the second portion is positioned or inserted in the receiving profile of the second safety panel. The positioning can be made possible, for example, by pushing in the second safety panel laterally. The abutting end sides of the two safety panels are pushed onto each other here. One of the safety panels can already be mounted in the outer frame.

The method can include a further step: sealing the butt joint between the first and the second safety panel, in particular the edge region of the butt joint, with a seal. The seal can be configured opaquely, as described above.

A foamable band can be arranged between the first and the second safety panel before the sealing. The resistance of the butt joint glazing can thereby be improved.

After the positioning of the second safety panel adjacent to the first safety panel, the second safety panel can be mounted in the outer frame. The mounting can also take place before the positioning; however, in this case, the mounting is intended to permit subsequent positioning of the second portion in the receiving profile of the second safety panel.

### BRIEF DESCRIPTION OF THE DRAWINGS

The subject matter of the invention will be explained in more detail below with reference to preferred exemplary embodiments which are illustrated in the attached drawings, in which, in each case schematically:

FIG. 1 shows a cross section through a safety panel;

FIG. 2 shows a cross section through a safety panel in the form of stepped insulated glass;

FIG. 3 shows a cross section through butt joint glazing with an insert element;

FIG. 4 shows a cross section through butt joint glazing with an insert element in the shape of a T profile;

FIG. 5 shows a cross section through butt joint glazing with an insert element in the shape of a T profile;

FIG. 6 shows a cross section through butt joint glazing of a step-like safety panel and insert element in the shape of a T profile, and a covering element; and

FIG. 7 shows butt joint glazing.

### DETAILED DESCRIPTION OF THE INVENTION

Identical or analogous parts are basically provided with the same reference signs in the figures.

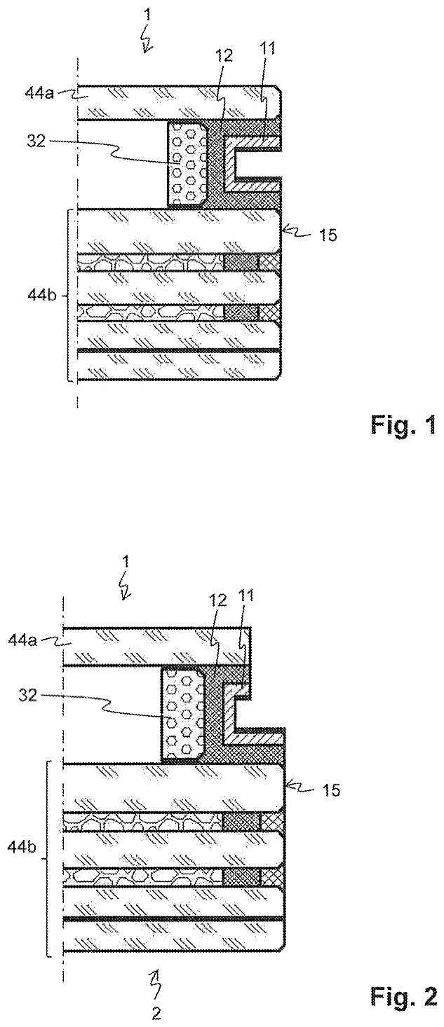

FIGS. 1 and 2 each show a cross section of a safety panel 1 for producing resistant, surface-flush butt joint glazing 2. The safety panel 1 has two plates 44, namely a first plate 44a and a second plate 44b. The two plates 44 and the safety panel 1 are substantially transparent. The two plates 44 are spaced apart from each other by a distance D with the aid of a spacer 32. The intermediate space between the two plates 44 is filled with an inert gas. The first plate 44a is configured as single-pane safety glazing. The second plate 44b is configured as composite glazing and has fire-protection glazing and a pane composite. The fire-protection glazing has three panes, between which a fire-protection interlayer reacting, in particular becoming cloudy, in the event of a fire is arranged. However, the fire-protection glazing may also have only two panes or at least two panes. The fire-protection glazing be E30 or E60 glazing. The fire-protection interlayer is surrounded in an encircling manner by a sealing compound. The pane composite is formed by adhesively bonding a pane of fire-protection glazing to a further pane. The adhesive bonding can be made possible, for example, by a film. A receiving profile 11 is arranged between the first plate 44a and the second plate 44b and is fastened between the two plates 44 with a sealing compound 12. The receiving profile can also be called a reinforcing profile. The receiving profile is arranged in a border region of the abutting end side of the safety panel and forms an open groove, i.e. a receptacle, which is also called open receiving profile side, toward the abutting end side. The abutting end side with the groove may also be called connection side or abutting side, and a further safety panel can be connected to the safety panel in a surface-flush manner without an additional frame via the connection side or abutting side.

The safety panel and/or the plate are/is a surface element, which includes two substantially parallel large outer surfaces, which are also called flat sides. In the present text, the encircling surface regions of the safety panel or of the plate between the flat sides are called “end sides”, and sometimes the terms “edge” or “narrow side” of a safety panel or of a plate are also used for this purpose. The end side here has a smaller surface than the flat sides, and an extent of the end side perpendicular to the large surfaces corresponds to the thickness of the safety panel or of the plate. A border region of the safety panel and/or of the plate, which border region can be arranged in a frame, may also be referred to as a border flange. The border region is therefore a region of the safety panel and/or of the plate, which is arranged in the vicinity of the end side. A rectangular safety panel or a rectangular plate includes four end sides; two opposite end sides can be referred to here as mounting end sides, and the other two end sides can be referred to as an abutting end side.

In the case of the safety panel 1 shown in FIG. 1, the two plates, i.e. the first plate and the second plate, each include two flat sides. The flat sides of the two plates substantially include identical dimensioning. The two plates therefore have the same size with respect to the flat side.

The abutting end side 15 shown in FIG. 2 is of step-like design, and the flat sides of the two plates 44 are dimensioned differently. That is to say, the first plate 44a is smaller than the second plate 44b.

As already described, the two plates 44 have a different construction and a different extent of the abutting end side and mounting end side, i.e. a different thickness.

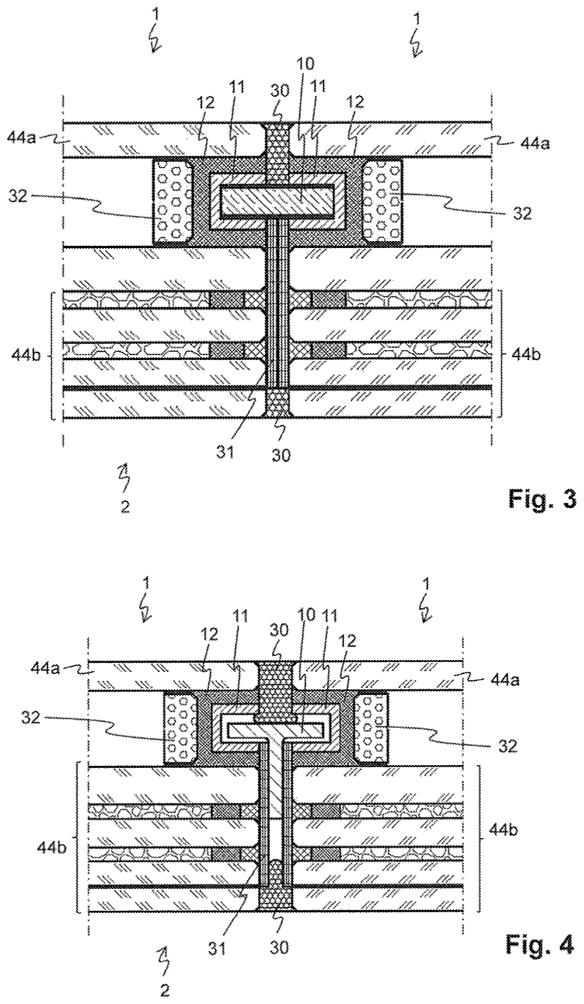

FIG. 3 shows a cross section of resistant butt joint glazing 2 with free abutting edges. The butt joint glazing 2 includes two safety panels 1 which are arranged in a surface-flush manner with respect to each other, as shown in FIG. 1. The two safety panels are arranged adjacent to each other along their abutting end side. Each of the two safety panels in each case includes two opposite mounting end sides. The mounting end sides are each mounted or held in an outer frame (not shown). A butt joint 21 is formed between the two adjacent safety panels 1; the butt joint 21 corresponds to a cavity between the adjacent safety panels 1. Between the first safety panel and the second safety panel, an insert element 10 is arranged along the butt joint 21 in the groove of the first safety panel and the groove of the second safety panel. The butt joint is sealed with a seal 30. This permits stabilization of the adjacent abutting edges of the butt joint glazing and protection against view and/or external effects, such as weather, wind and/or moisture. The receiving profile 11 is in the form of a flat profile. An outer frame 22 is not arranged in the region of the butt joint 21. A band 31, which is foamable or foams in the event of a fire, is arranged in the butt joint 21 and, in the event of a fire, permits sealing of the butt joint 21 against the passage of vapors and/or gases.

FIG. 4 shows a cross section of alternative, resistant butt joint glazing 2 with free abutting edges. The construction of the butt joint glazing 2 substantially corresponds to the construction of the butt joint glazing 2, as shown in FIG. 3. The insert element 10 is in the form of a T profile. The width of the T profile, i.e., the wide side, is formed by two feet, and the height of the T profile is formed by a web. The web extends substantially at a right angle from the feet. The wide side of the insert element 10 is arranged in the respective receiving profiles 11 of the adjacent safety panels 1. The web of the insert element 10 is arranged in the butt joint 21 of the butt joint glazing 2. The web is arranged between the second plate 44b of the adjacent safety panels 1.

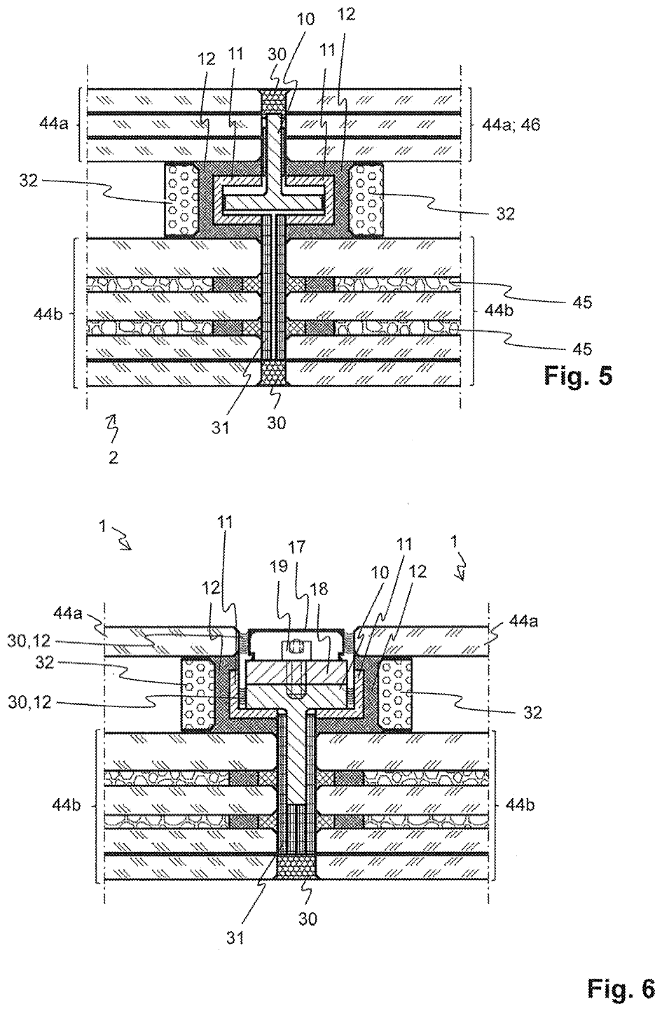

FIG. 5 shows a cross section of further, alternative, resistant butt joint glazing 2 with free abutting edges. The second plate 44b is configured similarly here to the second plate 44b shown in FIG. 1 or 2. The first plate 44a is configured as composite glass 46 and has three panes which are connected or adhesively bonded to one another by a composite film. However, the first plate 44a can also be configured as single-pane safety glass. The same applies to the second plate 44b. A combination with a fire-protection function, as shown in FIG. 5, such as, for example, the second plate 44b, can likewise be realized. The second plate 44b includes fire-protection intermediate layers 45 or a fire-protection interlayer between adjacent panes. Furthermore, one of the panes is configured as composite glass 46. The butt joint glazing 2 includes an insert element 10 in the shape of a T profile. The wide side of the insert element 10 is arranged in the respective receiving profiles 11 of the adjacent safety panels 1. The web of the insert element 10 is arranged in the butt joint 21 of the butt joint glazing 2. The web is arranged between the first plate 44a of the adjacent safety panels 1.

FIG. 6 shows a cross section of further, alternative, resistant butt joint glazing 2 with free abutting edges. The two safety panels 1 are of step-like design, similarly as shown in FIG. 2. The receiving profile 11 is configured as an L profile and has a receiving profile side, i.e. receptacle, which is open to the abutting end side 15. The insert element 10 is configured as a T profile, similarly as shown in FIG. 4 and FIG. 5. Additionally, the butt joint glazing 2 includes a covering element 17 which is configured to cover the butt joint 21 and the insert element 10 opaquely. The butt joint glazing 2 includes an insert reinforcement 18 which is fixed to the insert element 10 with a fastening means 19. The fastening means 19 is in the form of a screw-shaped, self-securing fastening means 19. After the screw connection of insert reinforcement 18 and insert element 10, the screw head has been sealed with a seal. The insert element 10 and the insert reinforcement 18 can therefore be connected exclusively by the forceful destruction of the fastening means 19. The resistance of the butt joint glazing 2 can thereby be improved. The covering element 17 and the insert element 10 are adhesively bonded into the butt joint 21. Before the insert element 10 is positioned in the receiving profile 11, the butt joint 21 is freely accessible, as a result of which the installation or construction of the butt joint glazing 2 and the interchanging of individual safety panels 1 from existing butt joint glazing 2 can be facilitated.

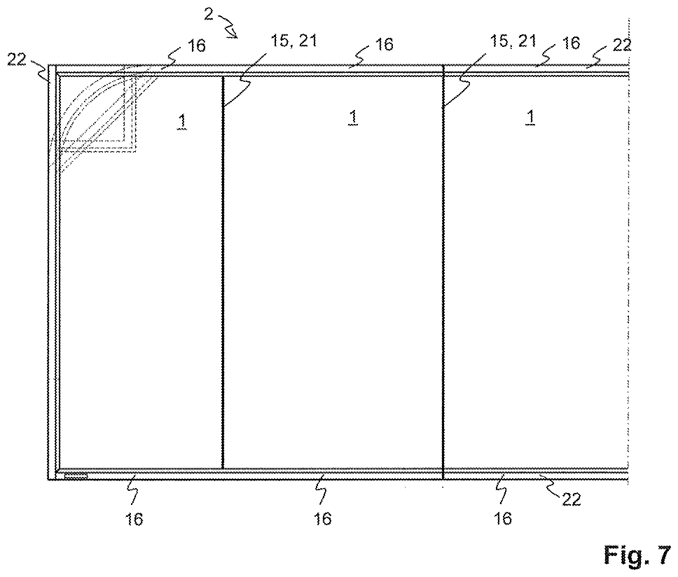

FIG. 7 shows butt joint glazing 2 with free abutting edges. The butt joint glazing 2 includes at least three safety panels 1 and an outer frame 22. The butt joint glazing 2 is a surface-flush glass façade or glazing. The safety panels 1 are arranged adjacent to one another along their abutting end side. The safety panels 1 are arranged in a surface-flush manner with respect to one another. Each of the safety panels 1 in each case includes two opposite mounting end sides 16. The mounting end sides 16 are each mounted or held in the outer frame 22. A border region of the safety panel 1 enters the outer frame 22 and is mounted or held in the border region. A butt joint 21 is in each case formed between the adjacent safety panels 1; the butt joint 21 corresponds to a cavity between the adjacent safety panels 1. Between the safety panels 1, the insert element 10 is arranged beyond the butt joint 21 in the groove of the adjacent safety panels 1. The butt joint 21 is sealed with a seal. This enables stabilization of the adjacent abutting edges of the butt joint glazing 2 and protection against view and/or external effects, such as weather, wind and/or moisture. The abutting edges run along the abutting end side 15 and therefore extend substantially at a right angle to the outer frame 22. The abutting edges of the butt joint glazing 2 are not covered by a frame, i.e., are frame-free or frameless. Visually attractive butt joint glazing, which includes, for example, burglar-resistant properties is thereby provided.

The safety panels 1 do not have to include any purely rectangular dimensioning of the flat sides. On the contrary, one or more safety panels 1 is can include a substantially rectangular shape in which, for example, the mounting end side 16, which is held in the outer frame 22, of the safety panel 1 is rounded, and includes a triangular flattening of the substantially rectangular shape and/or a recess in the corner region of the substantially rectangular shape of the safety panel 1, as illustrated by dashed lines in FIG. 6.

1. A transparent safety panel for producing resistant butt joint glazing which is surface flush on both sides,
wherein the safety panel
comprises at least one first plate, a second plate and a receiving profile, wherein the first plate and the second plate are spaced apart from each other,
wherein the safety panel comprises an abutting end side,
wherein the receiving profile is arranged between the first plats plate and the second plate, and
wherein the receiving profile is arranged in a border region of the abutting end side of the safety panel and has a receptacle which is opened toward the abutting end side.

2. The safety panel as claimed in claim 1, wherein the receiving profile contains metal, in particular ferrous or nonferrous metal.

3. The safety panel as claimed in claim 1, wherein the receiving profile is configured to receive an insert element, wherein the receiving profile is configured such that an insert element is pushable into the receiving profile along a push-in axis.

4. The safety panel according to claim 1, wherein the receiving profile is configured in a manner substantially free of undercuts.

5. The safety panel according to claim 1, wherein the receiving profile is arranged over the entire length of the butt joint end side.

6. The safety panel as claimed in claim 5, wherein the receptacle of the receiving profile has substantially the same cross section over an entire length of the receiving profile.

7. The safety panel according to claim 1, wherein the receiving profile is permanently fastened in the border region.

8. The safety panel according to claim 1, wherein the receiving profile is fastened in the border region of the safety panel with a sealing compound.

9. The safety panel as claimed in claim 1, wherein the receiving profile is arranged in a contact free manner in the border region of the safety panel.

10. The safety panel as claimed in claim 8, wherein the receiving profile is arranged in a thermally separated manner from the first and/or second plate.

11. The safety panel as claimed in claim 1, wherein the first and/or second plate is in the form of fire protection glazing.

12. The safety panel as claimed in claim 1, wherein the receiving profile ends in a substantially surface flush manner with the abutting end side of the safety panel.

13. The safety panel as claimed in claim 1, wherein the receiving profile is configured as a hollow profile.

14. The safety panel as claimed in claim 1, wherein the first plate and the second plate each comprise two flat sides, wherein the flat sides of the two plates substantially comprise identical dimensioning, and/or wherein the flat sides of the first plate are smaller than the flat sides of the second plate.

15. The safety panel as claimed in claim 14, wherein the abutting end side of the safety panel is of step like design for the surface flush receiving of a fastening means and/or of a covering.

16. The safety panel as claimed in claim 1, wherein the first plate and/or the second plate are/is in the form of safety glazing, fire protection glazing, insulating glazing and/or composite glazing, and/or comprise/comprises an integrated alarm function.

17. The safety panel as claimed in claim 1, wherein the mounting end side is free from a receiving profile.

18. The safety panel as claimed in claim 1, wherein the abutting end side runs vertically in the positioned state.

19. A set for producing resistant, surface flush butt joint glazing, wherein the set
comprises first and second safety panels as claimed in claim 1, and
an insert element,
wherein the insert element comprises a first portion and a second portion, wherein the first portion is dimensioned in such a manner that it can be positioned in the receptacle of the first safety panel,
wherein the insert element, projects beyond the end side of the first safety panel in the positioned state, and
wherein the projecting portion of the insert element is dimensioned in such a manner that it can be positioned in the receptacle of the second safety panel,
wherein, in the positioned state of the insert element in the respective receptacle, the two safety panels are arranged in a surface flush manner with respect to each other.

20. The set as claimed in claim 19, wherein the insert element extends substantially over the entire length of the receiving profile.

21. The set as claimed in claim 19, wherein the insert element exceeds the length of the receiving profile and projects beyond the mounting end side in the positioned state.

22. The set as claimed in claim 19, wherein the insert element is in the form of a flat profile, T profile and/or cross profile in a symmetrical and/or asymmetrical shape.

23. The set as claimed in claim 19, wherein the insert element can be inserted loosely into the receiving profile.

24. The set as claimed in claim 19, wherein the first portion of the insert element and the second portion of the insert element are in one piece.

25. The set as claimed in claim 19, comprising a covering element, wherein the covering element is configured to cover a butt joint.

26. The set as claimed in claim 19, wherein the set comprise an insert reinforcement which is fastenable to the insert element.

27. The set as claimed in claim 19, wherein the set comprise a foamable band which can be arranged between the first and the second safety panel.

28. The set as claimed in claim 27, wherein the foamable band substantially extends over the length of the abutting end side of the safety panel.

29. The set as claimed in claim 19, wherein the insert element is designed in such a manner that it does not protrude out of the surface flush butt joint glazing in the positioned state.

30. A resistant, surface-flush butt joint glazing, comprising a set as claimed in claim 19, and an outer frame which surrounds the butt joint glazing,
wherein the two safety panels are arranged adjacent to each other along their respective abutting end side, and the two safety panels are arranged in a surface flush manner with respect to each other,
wherein the safety panel in each case comprises two opposite mounting end sides which are in each case mounted in the outer frame, a border region of the safety panel enters in the outer frame and is held in said border region,
wherein a butt joint is formed between the two adjacent safety panels,
wherein, between the first safety panel and the second safety panel, the insert element is arranged beyond the butt joint in the receptacle of the first safety panel and in the receptacle of the second safety panel, and
wherein the butt joint is sealed with a seal.

31. The butt joint glazing as claimed in claim 30, wherein the insert element is inserted loosely into the receiving profile.

32. The butt joint glazing as claimed in claim 30, wherein the butt joint glazing is burglar resistant butt joint glazing of the resistance class RC1-RC6 (EN 1627:2011).

33. The butt joint glazing as claimed in claim 30, wherein the seal and/or the sealing compound comprise or comprises an opaque material.

34. The butt joint glazing as claimed in claim 30, wherein a band which foams in the event of fire is arranged in the butt joint.

35. The butt joint glazing as claimed in claim 30, wherein the butt joint glazing is a positionally fixed, resistant glazing.

36. The butt joint glazing as claimed in claim 30, comprising a covering element, wherein the covering element is configured in such a manner that it substantially extends over the length of the butt joint.

37. The butt joint glazing as claimed in claim 36, wherein the covering element is arranged in a substantially surface flush manner with the safety panel.

38. The butt joint glazing as claimed in claim 30, comprising a foamable band, wherein the foamable band is arranged in the butt joint.

39. The butt joint glazing as claimed in claim 38, wherein the foamable band substantially extends over the length of the butt joint.

40. The butt joint glazing as claimed in claim 30, wherein the butt joint substantially runs vertically.

41. An insert element for use in butt joint glazing as claimed in claim 30, wherein the insert element is in the form of a flat profile, T profile and/or cross profile in a symmetrical and/or asymmetrical shape, and in particular comprises a resistant material.

42. A method for producing resistant, surface flush butt joint glazing, wherein the method comprises the following steps:
providing a set as claimed in claim 19;
providing an outer frame;
fastening the outer frame in a building opening;
mounting at least one mounting side of the first safety panel in the outer frame;
inserting the insert element into the receiving profile of the first safety panel;
positioning the receiving profile of the second safety panel adjacent to the first safety panel, wherein the second portion of the insert element is positioned in the receiving profile of the second safety panel.

43. The method as claimed in claim 42, further comprising the step of:
sealing the butt joint between the first and the second safety panels with a seal (30).

44. The method as claimed in claim 42, wherein a foamable band is arranged between the first and the second safety panel before the sealing.

45. The method as claimed in claim 42, wherein, after the positioning of the second safety panel adjacent to the first safety panel, the second safety panel is mounted in the outer frame.
